(19) United States
(12) Patent Application Publication
(10) Pub. No.: US 2005/0074158 A1
(43) Pub. Date: Apr. 7, 2005

(54) Methods and apparatus for visualizing low contrast moveable objects

(76) Inventors: John Patrick Kaufhold, Schenectady, NY (US); David Allen Langan, Clifton Park, NY (US)

Correspondence Address: GENERAL ELECTRIC COMPANY (PCPI);C/O FLETCHER YODER, P. O. BOX 692289, HOUSTON, TX, 77269-2289, US

(21) Appl. No.: 10/679,850

(22) Filed: Oct. 6, 2003

(51) Int. Cl. G06K 9/00; G06K 9/40

(52) U.S. Cl. 382/132; 382/254

(57) ABSTRACT

Some configurations of the present invention provide a method for locating a low contrast movable object coupled mechanically to a marker object in a series of image frames that include images of the low contrast object and the marker object. The method includes locating the marker object in a first selected frame of the series of image frames, selecting a patch of the first selected frame as a template of the marker object, and utilizing the template of the marker object to estimate a location of the marker object in a second selected frame of the series of image frames. The second selected frame is registered with the first selected frame utilizing the estimated location of the marker object in the second selected frame. The registered first selected frame and the second selected frame are fused to thereby enhance the contrast of the low contrast moveable object.

### BACKGROUND OF THE INVENTION

This invention relates generally to methods and apparatus for image processing, and more particularly to methods and apparatus for enhancing the contrast of moving objects in images. Although the methods and apparatus of this invention are not limited to medical imaging applications, they are particularly useful for visualizing deployments of stents such as those used to remedy stenotic coronary arteries.

Coronary artery disease (CAD) is a common malady affecting millions of Americans. CAD refers to the buildup of plaques and fatty deposits on the interior walls of the coronary arteries, causing those vessels to narrow, thus restricting blood flow to the heart muscle. Remedies for CAD are critical to the American health care system because CAD can lead to heart attacks, which are the number one killer of Americans. A heart attack (or myocardial infarct, MI) occurs when the heart muscle's oxygen supply is severely restricted; in this case, the heart does not receive sufficient oxygen to perform its function. This MI may be caused by blocked blood flow through a narrow coronary artery (the coronary arteries supply the heart with oxygen via the blood). A narrowing in a vessel is termed a stenosis. Most of the time, although flow is reduced through a stenotic coronary, the oxygen supply to the heart is sufficient for normal function; however, when the heart is stressed, or if a circulating blockage lodges in the stenosis, the oxygen supply to the heart muscle becomes insufficient and the subject is at risk of damaging the heart through an MI. In some cases, though, no additional stress or blockage induces the MI—the coronaries in these cases are so narrow that metabolic processes in the rest state itself may induce the MI. Whatever the cause of the MI, the cardiovascular problems associated with CAD can be traced to the hemodynamics of the stenotic coronary artery. If the flow through the coronary can be restored, the health risks associated with CAD are significantly reduced.

One popular medical procedure designed to restore function to impaired coronary vessels is angioplasty. In angioplasty, a stenotic vessel (a coronary artery, for example) is pushed open by the force of a balloon. In theory, the opened vessel's blood flow is restored, and this restored flow again brings a healthy supply of oxygen to the heart. In practice, one problem with simply opening up a stenotic coronary artery with a balloon is that although in the short term, flow is restored, in a significant fraction of cases, some time after the balloon is removed, the mechanical force of the plaque that had caused the original stenosis reasserts itself and collapses the opened vessel. This process is called restenosis. The delay before restenosis can be as short as seconds to minutes.

To help prevent the restenosis effect, a stent is often used in addition to the balloon. A stent is a small metal tubular wire frame structure designed to add structural integrity to a vessel which has been opened. The medical procedure is most often initiated by preparing an “undeployed” stent around a balloon. An undeployed stent is simply a stent which is wrapped up so that it is a thinner cylinder than a “deployed” stent. The thinner cylinder can more easily be moved on guidewires through the patient's vasculature to the stenosis to be treated. Once in place, the balloon inside the stent is inflated. This inflation pressure has the same effect as a standard angioplasty in that the narrow vessel is opened. In theory, the advantage to using the stent is that now the opened vessel has a rigid scaffold to keep it open; this makes restenosis less likely.

In practice, however, fully deploying the stent in the vessel can be problematic. Partial deployment occurs when some parts of the stent are expanded to provide some rigid uniform radius scaffold to the vessel, but the stent did not fully expand to provide a rigid scaffold along the entire length of the stent. That is, the radius of the cylindrical stent varies along its length in a partially deployed stent, whereas in a fully deployed stent, the radius is approximately the same over the length of the stent. In current standard practice, to determine whether a stent is completely deployed, a cardiologist will administer an additional bolus of radioopaque contrast agent to visualize the flow through the stent on x-ray image sequences of the procedure. The flow profile through the stent will help the cardiologist assess the flow, and thereby, the stent deployment. The flow profile here refers to the intensity cross-section of the vessel with contrast agent flowing through it; specifically, the flow profile is the intensity profile of the x-ray image frame in the vicinity of the stented vessel in the direction perpendicular to the length (major axis) of the vessel.

If the profile of flow along the length of the stent is uniform, that is an indicator of proper stent deployment. If the flow profile along the length of the stent conforms to the shape of the original stenosis, or is otherwise nonuniform, that is an indicator of partial stent deployment. This standard practice for stent deployment assessment is usually a reasonable test. However, the administration of contrast agent should always be minimized. The radioactive dye contributes more dose to the patient, and for this reason, among others, the standard practice for stent deployment assessment is a dose-inefficient means to visualize stent deployment.

In cardiac imaging procedures such as stent placement, an operating cardiologist threads a number of devices (often a catheter and guidewire, at least) through the patient's tortuous vessels, starting at the femoral artery, for example, toward the coronary arteries. To assist in guiding the devices toward the patient's coronary arteries, a series of low-dose fluoroscopic x-rays may be acquired. These cardiac image sequences may also be recorded for future viewing. Once the catheter and guidewires have been positioned in or very near the coronary arteries, to better position the tools, the operating cardiologist may inject a bolus of radioactive contrast agent to make the coronary lumenal radii visible on the x-ray image sequences. The operating cardiologist is thus able to visualize the local vascular tree and any local stenoses in those vessels. After localizing a stenotic coronary artery, the cardiologist continues to navigate the instruments to the site of the stenosis. One challenge associated with the fine control of the positioning of the devices in stenoses is that the local vascular tree is always in motion due to both the beating heart and the respiration in the lungs.

In known prior art procedures, the stent is deployed using a balloon, which is inflated to expand the stenoic vessel and simultaneously deploy the stent. After inflation of the balloon, another cardiac sequence is acquired.

Standard practice requires injection of an additional bolus of a radioopaque contrast agent into the patient for the additional cardiac sequence to visualize a vessel that has been recently stented. By viewing the flow of contrast agent through the stent, stent deployment is assessed. However, in the standard practice, the injected bolus contributes additional radiation dose to the patient. Further, some patients with impaired kidney function either tolerate the contrast agent poorly or not at all.

### BRIEF DESCRIPTION OF THE INVENTION

There is therefore provided, in some configurations of the present invention, a method for locating a low contrast movable object (which may be, for example, a stent) coupled mechanically to a marker object in a series of image frames that include images of the low contrast object and the marker object. The method includes locating the marker object in a first selected frame of the series of image frames, selecting a patch of the first selected frame as a template of the marker object, and utilizing the template of the marker object to estimate a location of the marker object in a second selected frame of the series of image frames. The second selected frame is registered with the first selected frame utilizing the estimated location of the marker object in the second selected frame. The registered first selected frame and the second selected frame are fused to thereby enhance the contrast of the low contrast moveable object.

Some configurations of the present invention provide a method for locating a stent on a guidewire in a series of x-ray image frames of a patient utilizing one or more marker objects on the guidewire indicative of a location of the stent. The method includes locating the marker object in a first selected frame of the series of image frames and selecting a patch of the first selected frame as a template of the marker object. The template of the marker object is utilized to estimate a location of the marker object in a second selected frame of the series of image frames. The method also registers the second selected frame with the first selected frame utilizing the estimated location of the marker object in the second selected frame; and fuses the registered first selected frame and the second selected frame to thereby enhance the contrast of the stent in the second selected frame.

In yet other configurations of the present invention, an apparatus for tracking a motion of an object is provided. The apparatus includes a computer configured to process a series of image frames, and a display device. The apparatus is configured to locate the marker object in a first selected frame of the series of image frames, select a patch of the first selected frame as a template of the marker object, and utilize the template of the marker object to estimate a location of the marker object in a second selected frame of the series of image frames. The apparatus is also configured to register the second selected frame with the first selected frame utilizing the estimated location of the marker object in the second selected frame; and fuse the registered first selected frame and the second selected frame to thereby enhance the contrast of the low contrast moveable object.

Various methods and apparatus of the present invention enable visualization of a low contrast movable object. In some configurations, the low contrast moveable object is a stent, and a visualization of stent deployment is provided so that a cardiologist can better judge whether the deployment procedure is complete. If the cardiologist decides that it is not, he or she may elect to reestablish the stent in the vessel with a repeated deployment procedure. Various configurations of the present invention allow stent deployment assessment without requiring an additional bolus of contrast agent.

### BRIEF DESCRIPTION OF THE DRAWINGS

FIG. 1 is a first sample frame of a stenting procedure.

FIG. 2 is diagram showing a representative motion vector between two frames of a stenting procedure.

FIG. 3 is a flow chart representative of various configurations of methods of the present invention.

FIG. 4 is a representative x-ray image of devices inserted inside a patient, including contributions of the anatomy of the patient.

FIG. 5 is a representative x-ray image in which the contributions of the anatomy of the patient are substantially removed.

FIG. 6 is a representation of an initial marker ball template.

FIG. 7 is a new frame of an x-ray image sequence in which the contributions of the anatomy of the patient are substantially removed.

FIG. 8 is representative of an output frame in which correlation is mapped to pixel brightness.

FIG. 9 is a representative example of a refined template.

FIG. 10 is a representative example of an image without contrast enhancement.

FIG. 11 is a representative example of an image with contrast enhancement.

FIG. 12 is a block diagram representative of configurations of apparatus of the present invention and a representative x-ray imaging environment.

### DETAILED DESCRIPTION OF THE INVENTION

A technical effect of some of the configurations of the present invention described herein is the processing of image frames such as those obtained from x-ray imaging equipment to thereby produce enhanced images of a low contrast moveable object for display or, in some instances, for assessment of whether the moveable object has been successfully deployed.

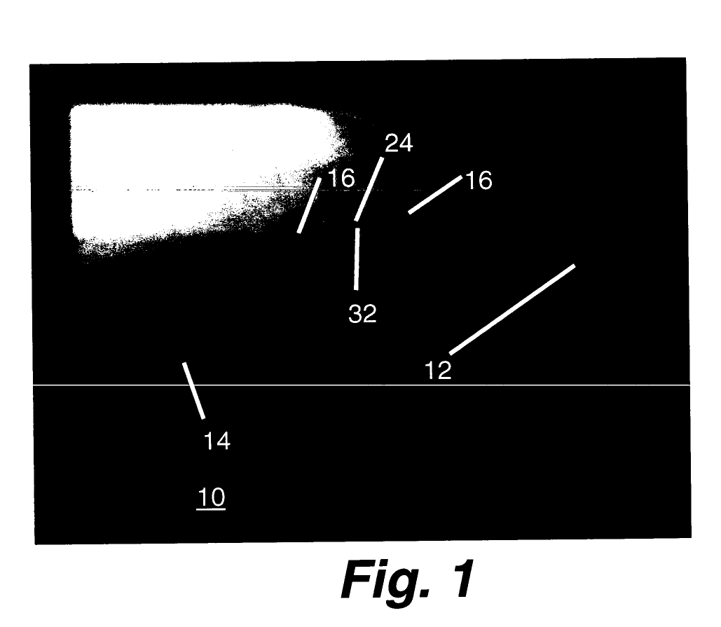

In some configurations of the present invention and referring to FIG. 1, a sample frame 10 of a stenting procedure is shown. This procedure usually is performed using a catheter 12, guidewire 14 with one or more (in this example, two) marker balls 16, and a stent 24 and associated balloon (inside stent 24, not separately visible in FIG. 1) anchored between marker balls 16. Guidewire 14 has been threaded through catheter 12 and marker balls 16 to indicate where on guidewire 14 the balloon is anchored inside stent 24. Although stent 24 is not readily visible in frame 10, marker balls 16 are indicative of the location of stent 24 and assist a cardiologist in visualizing its position. More particularly, in many configurations, the more highly visible marker balls 16 that are close to and on opposite sides of stent 24 on guidewire 14 serve to locate stent 24. In the stenting procedure, the balloon is inflated to expand the stenotic vessel and simultaneously deploy stent 24. After inflation of the balloon, another sequence of cardiac images is acquired.

As post-deployment cardiac sequence image frames are recorded, the relative locations of marker balls 16, guidewire 14, stent 24, and catheter 12 may all move from frame to frame. Thus, in various configurations of the present invention, the motion of stent 24 from frame to frame is estimated. Stent 24 by itself is difficult to accurately localize in two individual frames because its low contrast makes it difficult to see in either frame. However, during the stent 24 “deployment” procedure, stent 24 is usually fixed between a pair of marker balls 16 so that an operating cardiologist can localize stent 24 without seeing stent 24 outright. Because marker balls 16 are essentially fixed on guidewire 14 with respect to stent 24, the motion of marker balls 16 and of guidewire 14 together are used in some configurations of the present invention as a surrogate motion estimate for stent 24 itself. More particularly, if the motion of marker balls 16 from a previous frame in the image sequence to the current frame in the image sequence can be estimated, that estimate is used as an estimate of stent 24 motion.

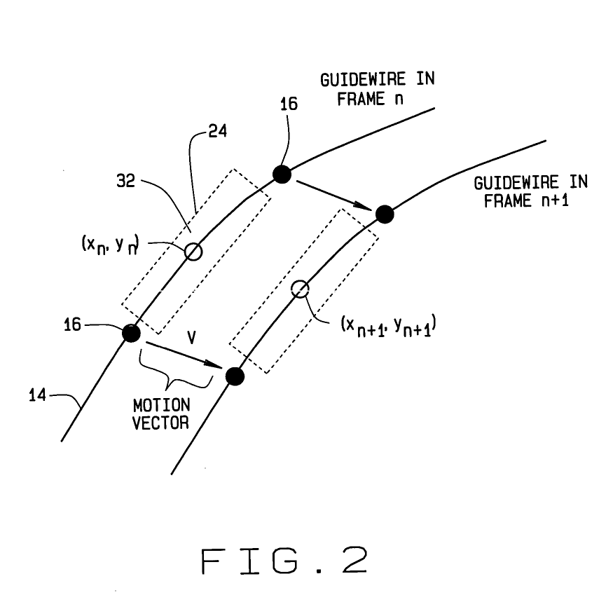

This surrogate motion estimate from marker balls 16 allows all frames to be “registered” with respect to the location of stent 24. Referring to frame 10 shown in FIG. 1 and FIG. 2, if in some frame n, such as frame 10, a centroid 32 of stent 24 is located at coordinates (xₙ,yₙ), and that at frame n+k, centroid 32 of stent 24 has moved to location (xₙ₊ₖ,yₙ₊ₖ), frame n+k can then be said to be “registered” via a “translation” such that centroid 32 of stent 24 in frame n+k also is at (xₙ,yₙ) in the frame n+k. As used herein in this context, “translation” refers to shifting of a coordinate system of pixels in one frame to correspond to a coordinate system defined about an object in another frame. For example, to register frame n+1 with frame n, coordinates in frame n+1 are shifted by an amount equal to a vector-V which exactly cancels the motion vector V of stent 24. The motion estimate of stent 24 from the previous to the current frame is the amount by which the current image must be translated to line up centroid 32 of stent 24 in the current frame with centroid 32 of stent 24 in the previous frame.

Once frames have been registered this way into a sequence, various configurations of the present invention fuse the registered frames. This fusing, in various configurations, can comprise or consist of signal averaging. In some configurations, this fusing enhances stent 24 because stent 24 appears in registered frames in approximately the same location in each frame, while an anatomical cardiac background of stent 24 can be assumed to be changing randomly. By fusing the registered images, stent 24 intensities constructively accumulate, whereas background intensities destructively interfere and smear. In this manner, the contrast of stent 24 is increased relative to the background and is such that stent 24 becomes visible, even though it may not be visible in any component image of the recorded image sequence. As used herein, “stent deployment integration” (SDI) imaging refers to a process in which a short image sequence is recorded, frame-to-frame stent 24 motion is estimated, sequence frames are registered, and the registered frames are “fused.” “Fused,” as used herein, refers to images combined using a selected smoothing algorithm, for example, signal averaging. Stent 24 can be visualized after a short recording of a number of image frames. The SDI image can be inspected by the physician to verify the success of the deployment of stent 24.

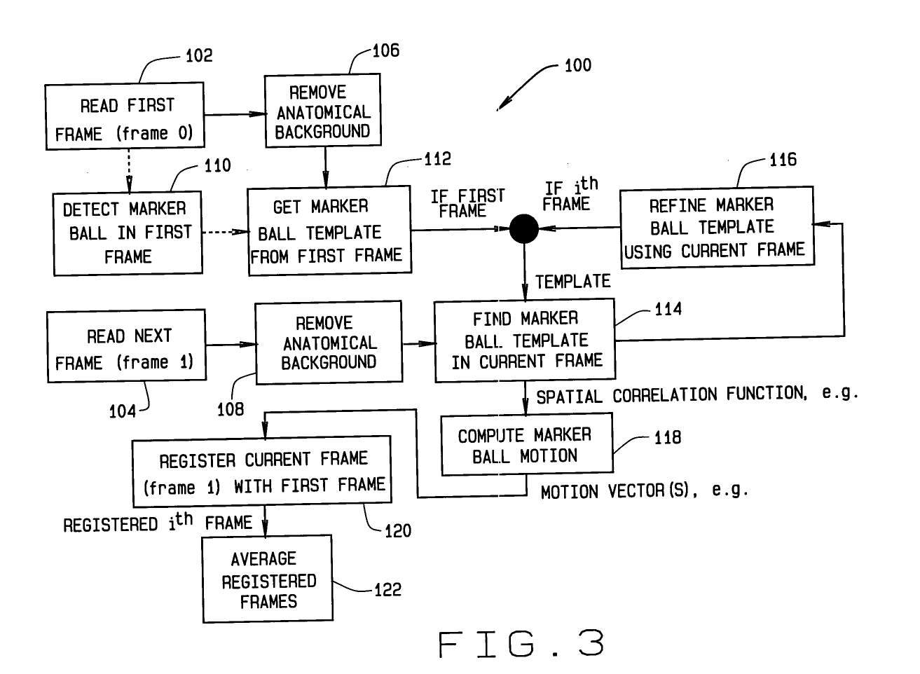

FIG. 3 is a block diagram of a method of the present invention in which the technical effect is the processing of images containing a low contrast moveable object to enhance the contrast of the moveable object.

In some configurations of the present invention, a first image frame of a cardiac image sequence with a catheter, guidewire with marker balls, and deployed stent is read into computer memory. The computer processes the image to reduce the anatomical background influence, thus enhancing the signature of the devices. (As used herein, the term “devices” in this context refers to the catheter, guidewire, marker balls, and stent.) A marker ball location is either found by the operating physician or the computer. A small image patch centered on the marker ball location is stored in computer memory as a marker ball template image. The next frame is read and similarly processed to enhance the devices. That enhanced image is then searched to find a location at which the marker ball template image is most highly correlated with the current device-enhanced frame. This location, the most likely location of the marker ball template, is found and recorded. The current frame is then translated so that the marker ball in the current frame has the same or approximately the same location as the marker ball in the first frames (i.e., the current frame is “registered” with the first frame). The registered frames are then fused, for example, by averaging. The fused (e.g., averaged or “integrated”) image is then displayed to the operating physician to assess the success or failure of the stent deployment.

More particularly and referring to flow chart 100 in FIG. 3, the first and subsequent frames are acquired for sequence processing at blocks 102, “Read First Frame (frame 0),” and 104, “Read Next Frame (frame i),” respectively. The function of blocks 102 and 104 is identical in some configurations with the exception of the frame being read. Blocks 102 and 104 each read an image from a computer storage device and use as read (i.e., in “raw” format), in some configurations. In other configurations, blocks 102 and 104 read the raw image and apply a transformation to the pixel intensities in the images. For example, a transformation is used in some configurations to increase the contrast of the devices in the image prior to processing. The output of block 102, “Read First Frame (frame 0)”, is a first frame, I₀(x,y). The output of block 104, “Read Next Frame (frame i)”, is the ith frame, Iᵢ(x,y). Both frames represent digital images stored in computer memory, although various formats may be used. For example, in some configurations, I₀(x,y) and I₁(x,y) are images of raw frame intensities, and in others, an image of the logarithms of frame intensities. Other formats for output images include, but are not limited to, an output comprising a dynamic range management (DRM) or a fluoroscopic noise reduction (FNR) algorithm applied to each raw frame, a specific scale of a multiresolution technique of a Laplacian Pyramid, or a frame in a transformed intensity domain. Pixel locations in each coordinate are indicated by x and y coordinates. The images may be raw images acquired from a digital flat panel detector, an image intensifier, or any other device capable of acquiring a series of x-ray cardiac images in rapid succession as to form a sequence of frames of the anatomy.

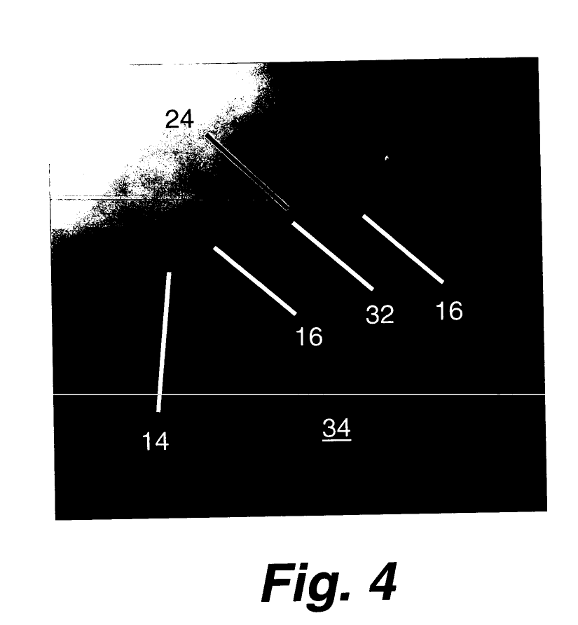

Images I₀(x,y) and Iᵢ(x,y) thus represent projection images of the devices that are inserted inside a patient. As such, these x-ray images comprise the contributions of the anatomy of the patient and of the devices inserted into the patient, as shown in frame 34 in FIG. 4.

The presence of an anatomical background complicates processing. Blocks 106 and 108, “Remove Anatomical Background,” which are identical in function in some configurations of the present invention, process image to remove the anatomical background. In some embodiments, a local median intensity is utilized by blocks 106 and 108 to remove the anatomical background. More specifically, a median filtered (device enhanced) version of an image frame can be written:
IDEᵢ(x,y)=I(x,y)−MF(I(x,y)),
where:
IDEᵢ is the (device enhanced) image with the anatomical background removed; and
MF(I) is the median-filtered version of I.

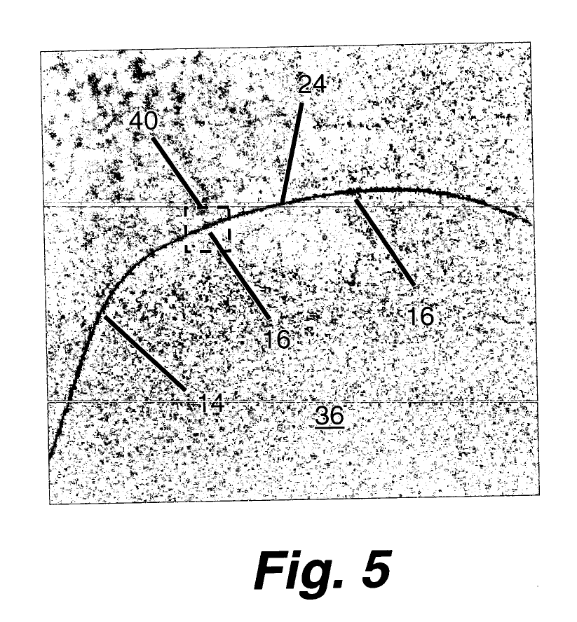

For example, Y=MF(I) may define a new image in which at each pixel location (x,y), Y(xⱼ,yⱼ) is the median of pixels in a local neighborhood of I(xⱼ,yⱼ). Frame 36 of FIG. 5 shows an example of an image in which anatomical background is removed in the manner described immediately above. Because median-filtered anatomical background removal is an approximation, a residual anatomical structure signal remains in IDEᵢ(x,y).

In other configurations, blocks 106 and 108 employ other techniques that enhance relative contrast compared to a background signal. For example, instead of a median filter, some configurations of the present invention utilize a linear filter such as a local weighted average of pixel intensities. In other configurations, the background is an interpolated version of the coarser image resulting from a multiresolution technique, for example, the background estimate is an interpolated version of the coarser scale image in a Laplacian Pyramid. In yet other configurations, each image is the image of the square root of frame intensities followed by removal of anatomical background. The square root representation of frame intensities results in noise having a constant variance over all background intensities, thereby simplifying the detection of the guide wire and marker ball. The simplification is particularly useful when contrast is low.

Block 110, “Detect Marker Ball in First Frame,” searches for a marker ball 16 on guidewire 14. In some embodiments, an operating cardiologist is presented with an image similar to frame 34 of FIG. 4. The cardiologist indicates marker ball (or balls) 16 utilizing a signal from a suitable apparatus, for example, a mouse click signal. An (x_{MB},y_{MB}) location of the pixel indicated in the image by this signal is recorded as marker ball 16 location for that frame. In some other configurations, a matched filter is used and template image patches of a marker ball on a guidewire are constructed for many different guidewire orientations. The (x_{MB},y_{MB}) at which the image produces the maximum response to the matched filter is located and identified as the location of marker ball 16 in that frame. Other processes can be used to determine an (x_{MB},y_{MB}) location indicative of the location of marker ball 16 in that frame, given a device-enhanced image frame IDE(x,y) as input.

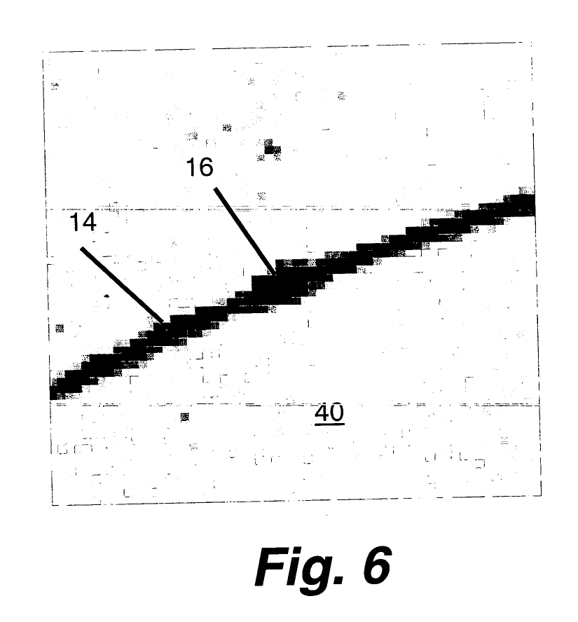

The whole image IDE(x,y) and the location of the marker ball, (x_{MB},y_{MB}) is provided as input to block 112, “Get Marker Ball Template from First Frame.” Block 112 outputs a subset of image IDE(x,y) in the vicinity of (x_{MB},y_{MB}). For example, a marker ball template 40 appears in frame 36 of FIG. 5. Marker ball template 40, shown enlarged in FIG. 6, is the output of block 112. The first smaller marker ball template image 40 is referred to herein as MBT₀(x,y).

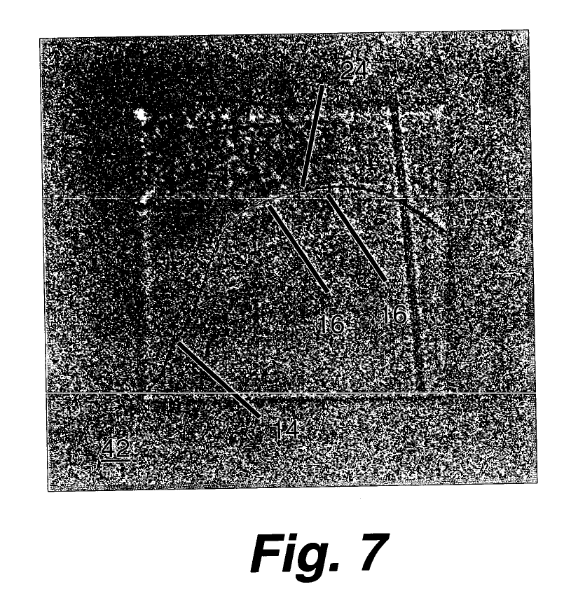

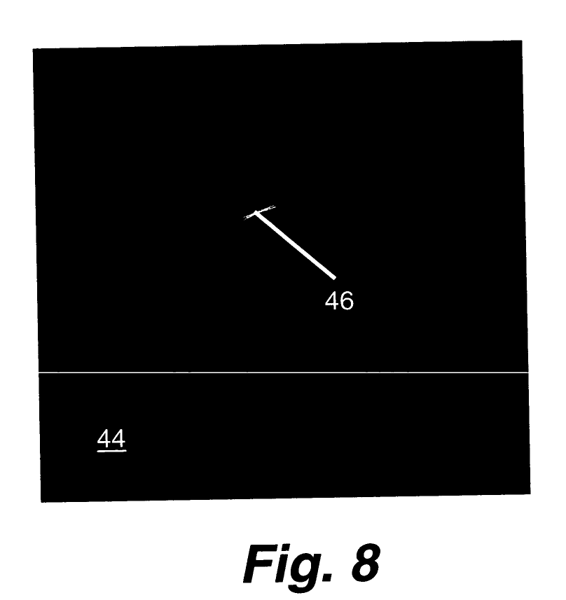

Block 114, “Find Marker Ball Template in Current Frame,” accepts as input a new frame of the image sequence, such as frame 42 shown in FIG. 7, and a marker ball template image 40, such as that shown in FIG. 6. Block 114 maps the likelihood that marker ball template 40 is in various locations in the current frame. For example, the correlation of image template 40 and current frame 42 is computed at every pixel in accordance with detection and estimation theory, utilizing any suitable known computation method in either the spatial or Fourier domain, for example. FIG. 8 is representative of an output frame 44 from such a correlation in which correlation is mapped to pixel brightness in a suitable fashion. For example, in configurations such as those for which frame 44 of FIG. 8 is representative, a higher correlation to marker ball template image 40 is indicated by a brighter pixel. Where the correlation is less, the corresponding pixel is darker. A bright band of intensities 46 in FIG. 8 indicates where the correlation is highest.

Block 114, in some configurations, uses a map of likely locations of marker ball template 50 in the current frame, for example, correlation image frame 44 of FIG. 8, to produce an (x,y) location estimate. If only correlation image 44 is used, as in some configurations, the location corresponding to the maximum value of the correlation image 44 is used as the (x,y) location of marker ball template image 40.

In some configurations of the present invention, block 114 utilizes a more general marker ball model that may include, for example, prior marker ball 16 locations and/or user-provided information. For example, in some configurations, a user provides additional information by indicating marker ball 16 location with a mouse click in each frame. Also, in some configurations, a computer utilizes software to analyze each image frame to find bulges on a curve. These bulges are then searched to find the best estimates of the current marker ball 16 location using previous marker ball 16 locations to refine the search.

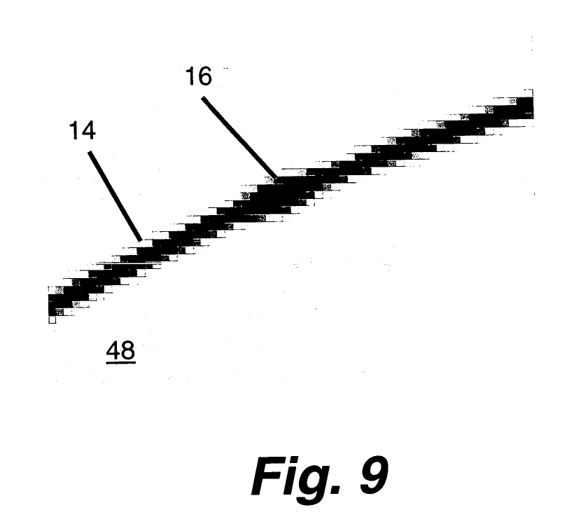

In various configurations of the present invention, device signatures are enhanced relative to the residual overlying anatomy background of any individual marker ball template 40 by fusing marker ball templates estimated at successive frames of the sequence, for example, by averaging. Thus, in some configurations, block 116, “Refine Marker Ball Template Using Current Frame,” uses first marker ball template 40, here denoted as, MBT₀, and a history of image patches corresponding to subsequent image patches about their respective marker ball location estimates, {MBT₁, MBT₂, . . . } to produce an image having enhanced device signatures. For example, to refine marker ball template 40 using two successive images, some configurations of the present invention average the two marker ball templates. Thus, once marker ball template position (x_{MBT1}, y_{MBT1}) estimated, the patch in IDE₁(x,y) about (x_{MBT1},y_{MBT1}), which is the same size as MBT₀, is taken as another estimate of the marker ball template. The contribution of the devices to the x-ray image in both should be the same because that dominant feature will have driven the correlation to match there. However, the backgrounds of both instances MBT₀, MBT₁, of the marker ball template will be different because marker ball 16 is moving through different residual anatomical structure and quantum noise. By signal averaging, the image contributions of the variable background on template 40 are reduced or even minimized and the signatures of the devices are enhanced. In this way, any appropriate number of marker ball template 40 images, MBTᵢ, can be averaged together to refine the template for motion estimation on all frames of the sequence. If the process is not done in real-time (which means, in this case, that no frame acquired subsequently can be used to refine a template for the current frame), an acausal average can be computed for optimal noise removal from the template in that frames acquired both “before” and “after” frame i can be used to refine the template for frame i. An example of a refined template 48 produced in this manner is shown in FIG. 9. The original MBT₀ in this example was template 40 shown in FIG. 6.

Block 118, “Compute Marker Ball Motion,” accepts (x,y) locations of marker ball template 40 from two successive frames and uses that information to determine a motion vector for frame Iᵢ(x,y) such that marker ball 16 in that image appears at essentially the same location as in previous frame Iᵢ₋₁(x,y). For example, if the (x,y) locations of marker ball template 40 from two successive frames are (x_{MBTi},y_{MBTi}) and (x_{MBTi-1},y_{MBTi-1}), then the motion vector that aligns the marker ball with the previous frame is v_{i,i-1}=(x_{MBTi}−x_{MBTi-1},y_{MBTi}−y_{MBTi-1}).

The Input to block 118 in some configurations is a sequence of images before and after the current frame, a template, a model for motion, and a sufficient statistic for assessing the confidence of a number of different motion estimates originating from the data and the models. The output is a motion estimate, and, in some configurations, other information such as a rotation estimate and/or an estimate of the distance between marker balls 16. Also in some configurations, outputs include an adaptation to the motion models and confidence metrics on the motion models themselves.

Some configurations utilize a matched filter to estimate motion. Other configurations use alternative or additional techniques. For example, a spatial correlation maximization technique is utilized on differences of device-enhanced frames in some configurations. In others, a marker ball template 40 is not updated with information from the image patch of the current frame. Instead, the first, ith, or last patch is used for all subsequent processing.

Other useful techniques that can be used in addition to, or as an alternative to matched filter estimation include optical flow techniques and Kalman filtering techniques. For example, using an optical flow technique, some configurations of the present invention detect a marker ball location in each frame. These locations are used for a motion estimate that is independent of a correlation function. Also in some configurations, the motion of two marker balls 16 are estimated at each frame, and a function (for example, an average) of the two motion estimates is used as a surrogate motion estimate for centroid 32 of stent 24. Some configurations fit a portion of guidewire 14 in the vicinity of stent 24 with a spline. Locations of the spline knot points from frame to frame are estimated, and a function of the motions of the knot points can be used as a surrogate motion estimate for centroid 32 of stent 24.

In various configurations, Kalman filtering techniques are used for optical flow estimation. For example, some configurations utilize a model of expected marker ball 16 motion in addition to information extracted from image data to predict the location of marker ball 16 in the next frame. For example, one prediction for the next frame marker ball 16 location is the location of marker ball 16 in the current frame. The model for marker ball 16 location is updated using measurements from the frames. For example, first and/or second derivatives are used to increase the accuracy of the prediction. Motion models in some configurations are sinusoidal functions adapted to the dominant motion estimate data from the image frames.

Some configurations utilizing Kalman filtering utilize statistics of the mean free path of marker ball 16 to detect outlier motion estimates from the data-driven update measurements to determine how much of the modeled motion to use and how much of the data-driven motion to use. In these configurations, the estimates are regularized with the predicted marker ball 16 locations. This technique is used in some configurations to restrict the search space for marker ball 16 locations in the current frame using the marker ball locations and trajectories of the previous frame.

In various configurations, the shape of the correlation function is used to estimate a confidence interval on newly measured marker ball 16 locations. This confidence interval estimate aids in deciding how much weight is applied to the model estimate and how much weight is applied to the data-driven motion estimate.

Also in some configurations, a simultaneously acquired electrocardiogram (EKG, or synonymously, ECG) is used for better quasi-periodic motion prediction. The EKG can be used to predict a projected distance between marker balls 16 in configurations in which two (or more) marker balls are found concurrently.

Block 120, “Register Current Frame with First Frame,” translates current frame Iᵢ(x,y) so that a marker ball 16 in the current frame is in approximately the same position as the same marker ball 16 in the first frame, using a coordinate system about marker ball 16 in the first frame as a reference. For example, if (x_{MBT0},y_{MBT0}) is the location of marker ball 16 in the first frame, where the top left pixel of I₀(x,y) has (x,y) coordinates (0,0), then Tᵢ(Iᵢ(x,y)) is a translated version of Iᵢ(x,y) in which marker ball 16 in Tᵢ(Iᵢ(x,y)) is at (x_{MBT0},y_{MBT0}) and the top left pixel of Tᵢ(Iᵢ(x,y)) has (x,y) coordinates (0,0).

In some configurations, block 120 translates the current frame to the original coordinate system in the first frame. This translation is accomplished, for example, by regridding for integer pixel motion estimates. In some configurations, interpolation techniques are used. In various configurations, the current frame is translated to the original coordinate system of the first frame and also rotated by an amount appropriate to account for interframe rotation. Also in various configurations, the current frame is also warped depending on motion estimates of marker balls 16, guidewire 14, and/or another metric provided by block 118.

Block 122 fuses a set of images, for example, by averaging. Thus, in various configurations, block 122, “Average Registered Frames,” pixelwise averages images {I₀(x,y), T₁(I₁(x,y)), T₂(I₂(x,y)), . . . Tₙ(Iₙ(x,y))}. The term “signal averaging” used herein also refers to this pixelwise averaging, which is used to enhance the signal to noise ratio of an underlying signal embedded in random noise. Specifically, at each pixel in an image, SDI(x,y) is written:

$$SDI ( x , y ) = \frac{1}{n + 1} ( {I}_{0} ( x , y ) + {\sum }_{i = 1}^{n} T ( {I}_{i} ( x , y ) ) ) .$$

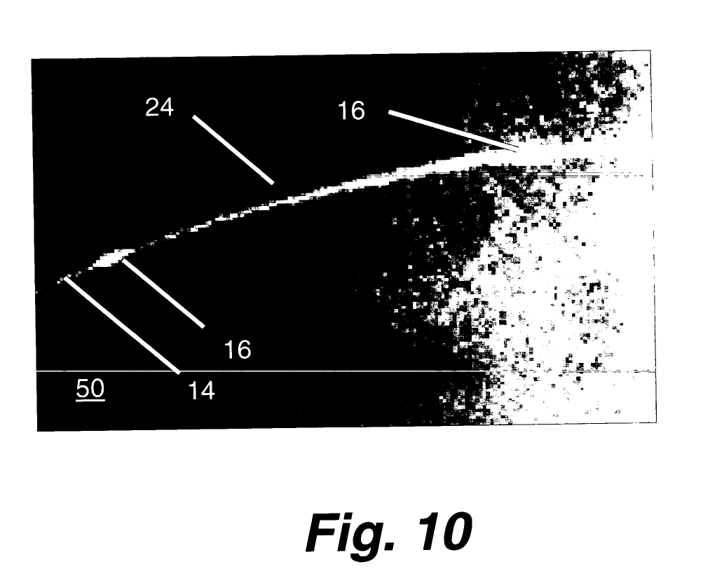

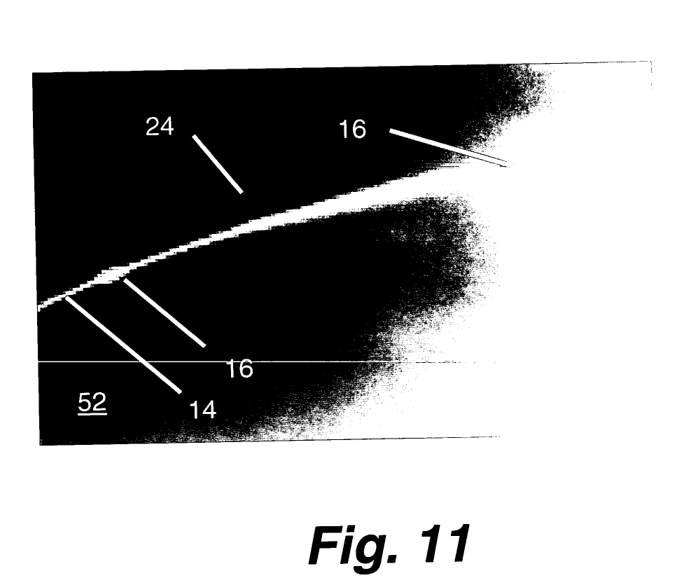

Thus, the SDI image enhances the contrast of guidewire 14 and marker balls 16 as a result of constructive accumulation over the image average. Likewise, because deployed stent 24 is essentially fixed with respect to marker balls 16, its contrast will also be enhanced. For example, referring to a constituent image Tᵢ(Iᵢ(x,y)), shown as frame 50 in FIG. 10, marker balls 16 and guidewire anchor 14 are visible, but stent 24 is completely invisible. A corresponding signal averaged image utilizing a configuration of the present invention is shown as frame 52 in FIG. 11. Frame 52 clearly shows the image of stent 24. A cardiologist can use enhanced images such as frame 52 to assess whether a stent deployment procedure was successful. Frame 52 shows a stent 24 having an hourglass shape, which indicates that stent 24 was not fully deployed in the middle of its length. A cardiologist would be able to determine from the shape of stent 24 in frame 52 that the only partial stent deployment had occurred, and that stent deployment was therefore unsuccessful.

A cardiologist using configurations of the present invention is thus able to visualize a stent without injecting an extra bolus of radio-opaque contrast agent. Visualization of the stent without this excess radioactive dye thus advantageously reduces the dose to the patient, the load on the patient's kidneys for clearance and the cost of total dye for procedure.

Stent-related uses of configurations of the present invention are not limited to visualization of stent deployment. In navigating a guidewire 14 through a patient, it is important not to catch on and push guidewire 14 through walls of preexisting stents in the patient. Some configurations of the present invention are useful as an aid in such device navigation. For example, the tip of guidewire 14 functionally replaces marker balls 16 in blocks 110, 112, 114, 116, and 118 in some configurations of the present invention in which the tip of guidewire 14 is used as a reference point. These configurations work best when the guidewire tip is not moving, or is moving very slowly relative to any preexisting stents in the patient. Some configurations also incorporate a moving window of registered frames to average for stent visualization. For example, in some configurations, all registered frames were included in the signal average. In configurations in which the guidewire tip (and thus the reference point) moves, the most recent frames provide the greatest amount of information about the current position. As a result, an average in SDI(x,y) may only be from n-n_{recent} to n, where n_{recent} is the number of recent frames to keep for the average.

Some configurations of the present invention utilize SDI techniques to provide an input image for a computer analysis, wherein the output of the computer analysis is an assessment of the stent deployment. A non-exclusive list exemplifying outputs in some configuration are: stent fully deployed, stent partially deployed, or stent fully deployed in wrong location, etc.

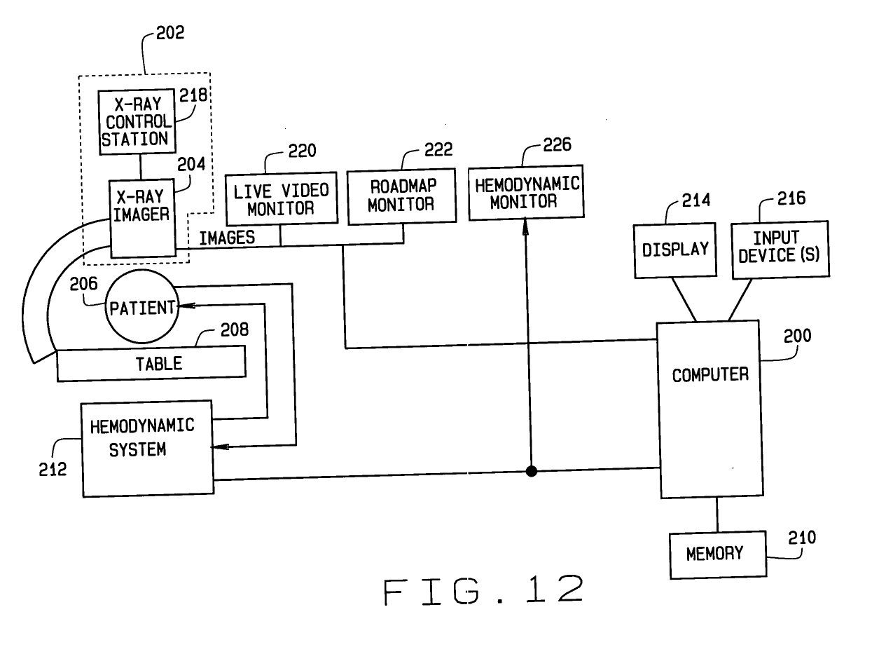

In some configurations and referring to FIG. 12, a computer 200 configured to perform one or more of the method configurations of the present invention receives images from an imaging apparatus 202. For example, imaging apparatus 202 comprises, in some configurations, an x-ray imager 204 that is configured to produce x-ray images of a patient 206 resting on a table 208 during a stenting operation. Imaging apparatus 202 may also comprise an x-ray station controller 218. Images produced by imaging apparatus are transferred to a database or, as shown in FIG. 12, a memory 210 of computer 200. Also in some configurations, a hemodynamic system 212, such as an electrocardiogram (ECG, or synonymously, EKG) monitor can be used for monitoring of patient 206. In some configurations, this EKG data is also sent to a database or a memory 210 of computer 200 and is used as motion data to further refine a template, a motion model, or both. Computer 200 may be provided with a display 214 for displaying contrast enhanced images and an input device or devices 216 (such as a keyboard and/or a mouse) for operator input. X-ray imager 204 is controlled by an operator at x-ray control station 218. Live video monitor 220 and roadmap monitor 222 display images that assist a surgeon in guiding a catheter through patient 206 and a technician operating x-ray control station 218. Hemodynamic monitor 226 may also be present, if an EKG is being taken, and used by the surgeon to aid in the operation. In some configurations, instead of utilizing display 214, enhanced images produced by computer 200 are displayed directly on video monitor 220. Thus, either display 214 or video monitor 220 (or another display) is a “display device” of an apparatus configured to perform one or more of the method configurations of the present invention. Also in some configurations, computer 200 is a part of imaging apparatus 202.

To configure computer 200 to perform various methods described herein and variations thereof, software or firmware is provided in a memory 210 of computer 200. This software includes instructions that instruct a processor in computer 200 to perform one or more of these methods.

Those of ordinary skill in the art will appreciate that the methods and apparatus described herein are not limited to stent deployment procedures. For example, the methods and apparatus of the present invention may also be used in other medical procedures in which a plurality of frames of a moving object are taken with an x-ray or other type of imaging device and enhanced contrast is advantageous. Moreover, configurations of the present invention need not be restricted to medical uses, but can more generally be used in other applications in which frames of a moving object are taken with an x-ray or other type of imaging apparatus and enhanced contrast is advantageous.

Unless further explicitly qualified, the terms “first,” “second,” etc., distinguish different instances of an object from one another without implying anything concerning their sequence, ranking of importance, etc., or other relative qualities or properties. For example, a “first selected frame” and a “second selected frame” merely refer to two different selected frames. However, a “first selected frame” and a “second, subsequently selected frame” refers to a second selected frame selected at a time subsequent to the selection of the first selected frame.

While the invention has been described in terms of various specific embodiments, those skilled in the art will recognize that the invention can be practiced with modification within the spirit and scope of the claims.

1. A method for locating a low contrast movable object coupled mechanically to a marker object in a series of image frames that include images of the low contrast object and the marker object,
said method comprising:
locating the marker object in a first selected frame of the series of image frames;
selecting a patch of the first selected frame as a template of the marker object;
utilizing the template of the marker object to estimate a location of the marker object in a second selected frame of the series of image frames;
registering the second selected frame with the first selected frame utilizing the estimated location of the marker object in the second selected frame; and
fusing the registered first selected frame and the second selected frame to thereby enhance the contrast of the low contrast moveable object.

2. A method in accordance with claim 1 wherein said registering the second selected frame with the first selected frame comprises estimating a motion of the marker object between the first selected frame and the second selected frame.

3. A method in accordance with claim 1 further comprising removing a background from the first selected frame prior to selecting the template of the marker object in the first selected frame.

4. A method in accordance with claim 1 further comprising removing a background from the second selected frame prior to utilizing the template of the marker object from the first selected frame to estimate the location of the marker object in the second selected frame.

5. A method in accordance with claim 1 wherein the second selected frame is a frame subsequent to the first selected frame, and said method further comprises utilizing the second selected frame to modify the template of the marker object.

6. A method in accordance with claim 5 wherein said utilizing the second selected frame to modify the template of the marker object comprises utilizing frames acquired both before and after the second selected frame to modify the template of the marker object.

7. A method in accordance with claim 1 wherein the first selected frame and the second selected frame comprise intensities of a first image and of a second image, respectively, stored in a computer memory.

8. A method in accordance with claim 1 wherein the first selected frame and the second selected frame comprise logarithms of intensities of a first image and of a second image, respectively, stored in a computer memory.

9. A method in accordance with claim 1 further comprising removing a background from the first selected image and from the second selected image.

11. A method in accordance with claim 9 wherein said removing a background comprises utilizing a local median intensity to remove the background.

12. A method in accordance with claim 9 wherein said removing a background comprises utilizing a linear filter.

13. A method in accordance with claim 9 wherein said removing a background comprises interpolating the background of a coarser scale image in a Laplacian Pyramid.

14. A method in accordance with claim 1 further comprising taking a square root of frame intensities of the first selected frame and the second selected frame, followed by removing a background from the first selected frame and from the second selected frame.

15. A method in accordance with claim 1 wherein said locating the marker object in a first selected frame comprises signaling a location of the marker object utilizing a mouse click signal.

16. A method in accordance with claim 1 wherein said locating the marker object in a first selected frame comprises utilizing a matched filter to locate a point at which the first selected frame produces a maximum response to the matched filter.

17. A method in accordance with claim 1 wherein said utilizing the template of the marker object to estimate a location of the marker object in a second selected frame comprises correlating the template of the marker object with the second selected frame in either a spatial or a Fourier domain.

18. A method in accordance with claim 1 wherein said utilizing the template of the marker object to estimate a location of the marker object in a second selected frame further comprises utilizing prior marker object locations to estimate the location of the marker object in the second selected frame.

19. A method in accordance with claim 1 wherein said utilizing the template of the marker object to estimate a location of the marker object in a second selected frame of the series of image frames further comprises utilizing a Kalman filter to estimate motion of the marker object.

20. A method in accordance with claim 19 further comprising utilizing a statistic of a mean free path of the marker object to determine how much modeled motion to utilize and how much data-driven motion to utilize in the Kalman filter.

21. A method in accordance with claim 19 further comprising estimating a confidence interval on a location of the marker object.

22. A method in accordance with claim 1 wherein said utilizing the template of the marker object to estimate a location of the marker object in a second selected frame of the series of image frames comprises locating two marker objects and fitting a portion of a connecting member between the two marker objects with a spline.

23. A method in accordance with claim 1 wherein said registering the second selected frame with the first selected frame utilizing the estimated location of the marker object in the second selected frame comprises regridding.

24. A method in accordance with claim 1 wherein said registering the second selected frame with the first selected frame utilizing the estimated location of the marker object in the second selected frame comprises a translation and a rotation.

25. A method in accordance with claim 1 wherein said registering the second selected frame with the first selected frame utilizing the estimated location of the marker object in the second selected frame further comprises a warping.

26. A method in accordance with claim 1 wherein said fusing the registered first selected frame and the second selected frame to thereby enhance the contrast of the low contrast moveable object comprises pixelwise averaging.

27. A method for locating a stent on a guidewire in a series of x-ray image frames of a patient utilizing one or more marker objects on the guidewire indicative of a location of the stent,
said method comprising:
locating the marker object in a first selected frame of the series of image frames;
selecting a patch of the first selected frame as a template of the marker object;
utilizing the template of the marker object to estimate a location of the marker object in a second selected frame of the series of image frames;
registering the second selected frame with the first selected frame utilizing the estimated location of the marker object in the second selected frame; and
fusing the registered first selected frame and the second selected frame to thereby enhance the contrast of the stent in the second selected frame.

28. A method in accordance with claim 27 wherein said registering the second selected frame with the first selected frame comprises estimating a motion of the marker object between the first selected frame and the second selected frame.

29. A method in accordance with claim 27 further comprising removing an anatomical background from the first selected frame prior to selecting the template of the marker object in the first selected frame.

30. A method in accordance with claim 27 further comprising removing an anatomical background of the patient from the second selected frame prior to utilizing the template of the marker object from the first selected frame to estimate the location of the marker object in the second selected frame.

31. A method in accordance with claim 27 wherein the second selected frame is a frame subsequent to the first selected frame, and said method further comprises utilizing the second selected frame to modify the template of the marker object.

32. A method in accordance with claim 31 wherein said utilizing the second selected frame to modify the template of the marker object comprises utilizing frames acquired both before and after the second selected frame to modify the template of the marker object.

33. A method in accordance with claim 27 further comprising removing an anatomical background from the first selected image and from the second selected image.

34. A method in accordance with claim 33 wherein said removing an anatomical background comprises utilizing a local median intensity to remove the background.

35. A method in accordance with claim 33 wherein said removing an anatomical background comprises utilizing a linear filter.

36. A method in accordance with claim 33 wherein said removing an anatomical background comprises interpolating the background of a coarser scale image in a Laplacian Pyramid.

37. A method in accordance with claim 27 wherein said locating the marker object in a first selected frame comprises utilizing a matched filter to locate a point at which the first selected frame produces a maximum response to the matched filter.

38. A method in accordance with claim 27 wherein said utilizing the template of the marker object to estimate a location of the marker object in a second selected frame comprises correlating the template of the marker object with the second selected frame in either a spatial or a Fourier domain.

39. A method in accordance with claim 27 wherein said utilizing the template of the marker object to estimate a location of the marker object in a second selected frame of the series of image frames comprises locating two marker objects and fitting a portion of a connecting member between the two marker objects with a spline.

40. A method in accordance with claim 27 wherein said registering the second selected frame with the first selected frame utilizing the estimated location of the marker object in the second selected frame comprises a translation and a rotation.

41. A method in accordance with claim 27 wherein the second selected image is an x-ray image acquired later than the first selected image, and further comprising attempting to deploy the stent and utilizing the enhanced contrast of the stent to determine whether the stent has been successfully deployed.

42. A method in accordance with claim 41 performed without injection of a contrast-enhancing bolus after the deployment of the stent.

43. An apparatus for tracking a motion of an object, said apparatus comprising a computer configured to process a series of image frames, and a display device,
said apparatus configured to:
locate the marker object in a first selected frame of the series of image frames;
select a patch of the first selected frame as a template of the marker object;
utilize the template of the marker object to estimate a location of the marker object in a second selected frame of the series of image frames;
register the second selected frame with the first selected frame utilizing the estimated location of the marker object in the second selected frame; and
fuse the registered first selected frame and the second selected frame to thereby enhance the contrast of the low contrast moveable object.

44. An apparatus in accordance with claim 43 wherein to register the second selected frame with the first selected frame, said apparatus is configured to estimate a motion of the marker object between the first selected frame and the second selected frame.

45. An apparatus in accordance with claim 43 further configured to remove a background from the first selected frame prior to selecting the template of the marker object in the first selected frame.

46. An apparatus in accordance with claim 43 further configured to remove a background from the second selected frame prior to utilizing the template of the marker object from the first selected frame to estimate the location of the marker object in the second selected frame.

47. An apparatus in accordance with claim 43 wherein the second selected frame is a frame subsequent to the first selected frame, and said apparatus is further configured to utilize the second selected frame to modify the template of the marker object.

48. An apparatus in accordance with claim 43 wherein to utilize the second selected frame to modify the template of the marker object, said apparatus is configured to utilize frames acquired both before and after the second selected frame to modify the template of the marker object.

49. An apparatus in accordance with claim 43 further comprising a memory, and wherein the first selected frame and the second selected frame comprise intensities of a first image and of a second image, respectively, stored in a computer memory.

50. An apparatus in accordance with claim 43 further comprising a memory, and wherein the first selected frame and the second selected frame comprise logarithms of intensities of a first image and of a second image, respectively, stored in the memory.

51. An apparatus in accordance with claim 51 further configured to remove a background from the first selected image and from the second selected image.

52. An apparatus in accordance with claim 51 wherein to remove the background, said apparatus is configured to utilize a local median intensity to remove the background.

53. An apparatus in accordance with claim 51 wherein to remove the background, said apparatus is configured to utilize a linear filter.

54. An apparatus in accordance with claim 51 wherein to remove the background, said apparatus is configured to interpolate the background of a coarser scale image in a Laplacian Pyramid.

55. An apparatus in accordance with claim 43 further configured to take a square root of frame intensities of the first selected frame and the second selected frame, and subsequently to remove a background from the first selected frame and from the second selected frame.

56. An apparatus in accordance with claim 43 wherein to locate the marker object in the first selected frame, said apparatus is configured to receive an indication of a location of the marker object signaled by a mouse click.

57. An apparatus in accordance with claim 43 wherein to locate the marker object in a first selected frame, said apparatus is configured to utilize a matched filter to locate a point at which the first selected frame produces a maximum response to the matched filter.

58. An apparatus in accordance with claim 43 wherein to utilizing the template of the marker object to estimate a location of the marker object in a second selected frame, said apparatus is configured to correlate the template of the marker object with the second selected frame in either a spatial or a Fourier domain.

59. An apparatus in accordance with claim 43 wherein to utilize the template of the marker object to estimate a location of the marker object in a second selected frame, said apparatus is configured to utilize prior marker object locations to estimate the location of the marker object in the second selected frame.

60. An apparatus in accordance with claim 43 wherein to utilize the template of the marker object to estimate a location of the marker object in a second selected frame of the series of image frames, said apparatus is further configured to utilize a Kalman filter to estimate motion of the marker object.

61. An apparatus in accordance with claim 60 further configured to utilize a statistic of a mean free path of the marker object to determine how much modeled motion to utilize and how much data-driven motion to utilize in the Kalman filter.

62. An apparatus in accordance with claim 60 further configured to estimate a confidence interval on a location of the marker object.

63. An apparatus in accordance with claim 62 wherein to utilize the template of the marker object to estimate a location of the marker object in a second selected frame of the series of image frames, said apparatus is configured to locate two marker objects and fit a portion of a connecting member between the two marker objects with a spline.

64. An apparatus in accordance with claim 43 wherein to register the second selected frame with the first selected frame utilizing the estimated location of the marker object in the second selected frame, said apparatus is configured to translate and to rotate said second selected frame.

65. An apparatus in accordance with claim 43 configured to pixelwise average the registered first selected frame and the second selected frame to thereby enhance the contrast of the low contrast moveable object.

66. An apparatus in accordance with claim 43 wherein said apparatus further comprises an x-ray imager, and said image frames comprise x-ray images.
